(19) United States
(12) Patent Application Publication
(10) Pub. No.: US 2022/0197304 A1
(43) Pub. Date: Jun. 23, 2022

(54) SYSTEMS AND METHODS FOR CENTRALIZED CONTROL OF A FLEET OF ROBOTIC DEVICES

(71) Applicant: Verizon Patent and Licensing Inc., Basking Ridge, NJ (US)

(72) Inventors: Laura Helen COCHRAN, Arvada, CO (US); Rejaul MONIR, Jamaica Hills, NY (US); Joel YAFFE, Long Island City, NY (US); Aamir HUSAIN, New Brunswick, NJ (US); Derek Wade OHLARIK, Flemington, NJ (US)

(73) Assignee: Verizon Patent and Licensing Inc., Basking Ridge, NJ (US)

(21) Appl. No.: 17/126,724

(22) Filed: Dec. 18, 2020

(51) Int. Cl. G05D 1/02

(52) U.S. Cl. CPC G05D 1/0291

(57) ABSTRACT

In some implementations, a device may receive status information for robotic devices. The status information may include locations and navigation plans of the robotic devices. The device may monitor, based on the status information, individual statuses of the robotic devices. The device may receive a mission request associated with performance of an operation. The device may select, based on the individual statuses, a first robotic device to perform the operation. The device may determine, based on a mapping of an environment, potential navigation plans associated with the first robotic device traversing the environment according to the operation. The device may select a navigation plan based on the locations and the navigation plans of the robotic devices. The device may stream navigation instructions associated with the selected navigation plan to the first robotic device to cause the first robotic device to traverse the environment according to the navigation plan.

### BACKGROUND

A robotic device is a machine that can be programmed to carry out a series of actions automatically. The robotic device may be guided by a control device. The control device may be an external control device or an internal control device embedded within the robotic device.

### BRIEF DESCRIPTION OF THE DRAWINGS

FIGS. 1A-1E are diagrams of an example associated with centralized control of a fleet of robotic devices.

FIG. 2 is a diagram of an example environment in which systems and/or methods described herein may be implemented.

FIG. 3 is a diagram of example components of one or more devices of FIG. 2.

FIG. 4 is a flowchart of an example process relating to centralized control of a fleet of robotic devices.

### DETAILED DESCRIPTION OF PREFERRED EMBODIMENTS

The following detailed description of example implementations refers to the accompanying drawings. The same reference numbers in different drawings may identify the same or similar elements.

Commonly, to enable a robotic device to navigate and/or perform a task, the robotic device requires onboard sensors, computers, high density maps, and data. All of these features need to run locally on the robotic device to allow it to navigate and carry out tasks. The robotic device typically has its own map, operates independently within a particular environment (e.g., a warehouse, an office space, a floor of a building, and/or the like), and does not have a scalable way of interacting with other entities (e.g., another robotic device, a person, and/or the like) within the particular environment. As such, the robotic device may be slow, unsafe, and may often need to operate in a caged environment to avoid collisions with other entities moving within the robotic device's particular environment.

Some implementations described herein relate to a centralized fleet control system configured to control a fleet of robotic devices. The centralized fleet control system may be positioned within an edge compute environment and may monitor and/or control, in real-time, the robotic devices based on information provided by the robotic devices via a low-latency, wireless communication link. For example, the centralized fleet control system may receive, via a network, first mission information associated with a first robotic device, of a fleet of robotic devices, performing a first operation, and second mission information associated a second robotic device, of the fleet of robotic devices, performing a second operation. The centralized fleet control system may determine a first navigation plan for the first robotic device to perform the first operation and a second navigation plan for the second robotic device to perform the second operation based on the first mission information, the second mission information, one or more other navigation plans associated with one or more other robotic devices of the fleet of robotic devices, and a mapping of an environment of the enterprise. The centralized fleet control system may provide, via the network, the first navigation plan and the first mission information to the first robotic device to cause the first robotic device to perform the first operation according to the first navigation plan and may provide, via the network, the second navigation plan and the second mission information to the second robotic device to cause the second robotic device to perform the second operation according to the second navigation plan.

In this way, the centralized fleet control system may centralize control of a fleet of mobility-enabled, connected, robotic devices to enable the positioning and navigation, communication, collision prevention, coordination, and task operation of the robotic devices. Further, the centralized fleet control system may utilize commands, messaging formats, and/or the like obtained from an original equipment manufacturer (OEM) of the robotic devices thereby enabling the centralized fleet control system to control a heterogenous mixture of multiple different types of robotic devices. The centralized fleet control system eliminates the need for expensive sensors, onboard processing, and local data hosting requirements for the robotic devices and creates scalable and centralized inter-robotic device collaboration and coordination.

Further, the centralized fleet control system may run all processing for the fleet of robotic devices on an edge computer over a low latency wireless link (e.g., a 5G communication link, a WiFi communication link, a Bluetooth communication link, a near-field communication link, and/or the like). As a result, virtually all software, algorithms, and architecture are run on an edge computer, rather than a robotic device, thereby enabling the robotic devices to execute only motor control commands received from the centralized fleet control system. The centralized fleet control system can manage hundreds, thousands, and/or tens of thousands of robotic devices by simultaneously ingesting sensor information received from the robotic devices, using artificial intelligence (AI) and machine learning (ML) to process the sensor information in near real-time to enable centralized multi-robotic device localization in near real-time using a global map, collision avoidance between dynamic and static objects around all robotic devices and robotic device traffic management, real-time object recognition and decision making for all robotic devices, real-time path planning and navigation for all robotic devices, real-time mission execution on all robotic devices, centralized safety command system reacting in near real-time speed, inter-robotic device collaboration and cooperation, and/or the like.

The centralized fleet management system may run processing under the context of a unified three-dimensional (3D) map of the environment for a fleet of heterogeneous robotic devices. In this way, the centralized fleet management system allows any robotic device in the fleet, regardless of its software/ecosystem, to interact and collaborate with other robotic devices within the centralized 3D world from a centralized software system running on an edge computer. Further, the use of AI and ML-based distributed software architecture, combined with the power of low latency wireless link and edge computing, enables the centralized fleet management system to make real time decisions, thereby increasing safety, enabling human-robotic device co-existence, and enabling highly scalable inter-robotic device collaboration and cooperation.

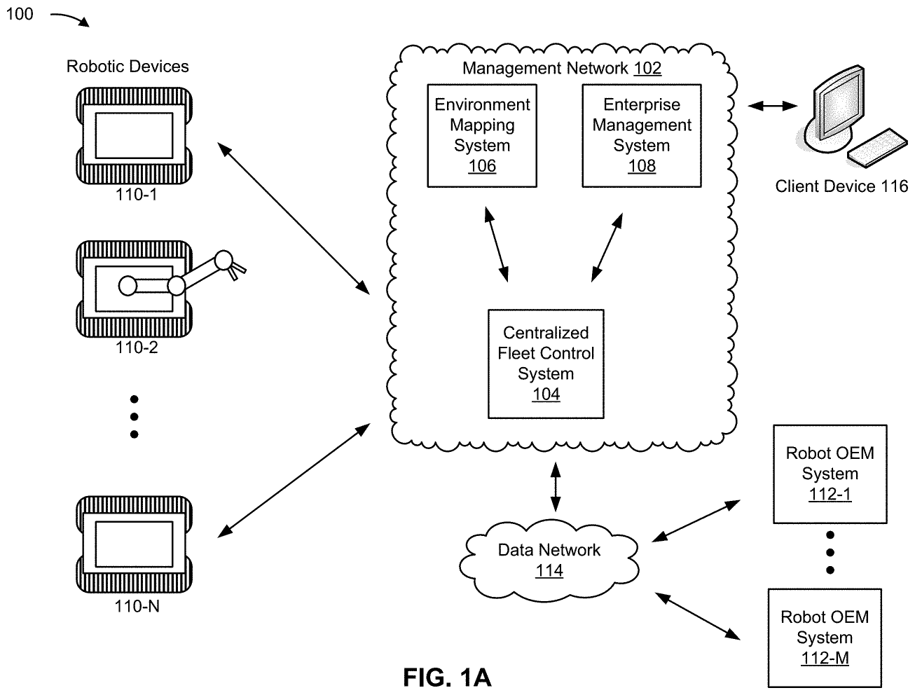

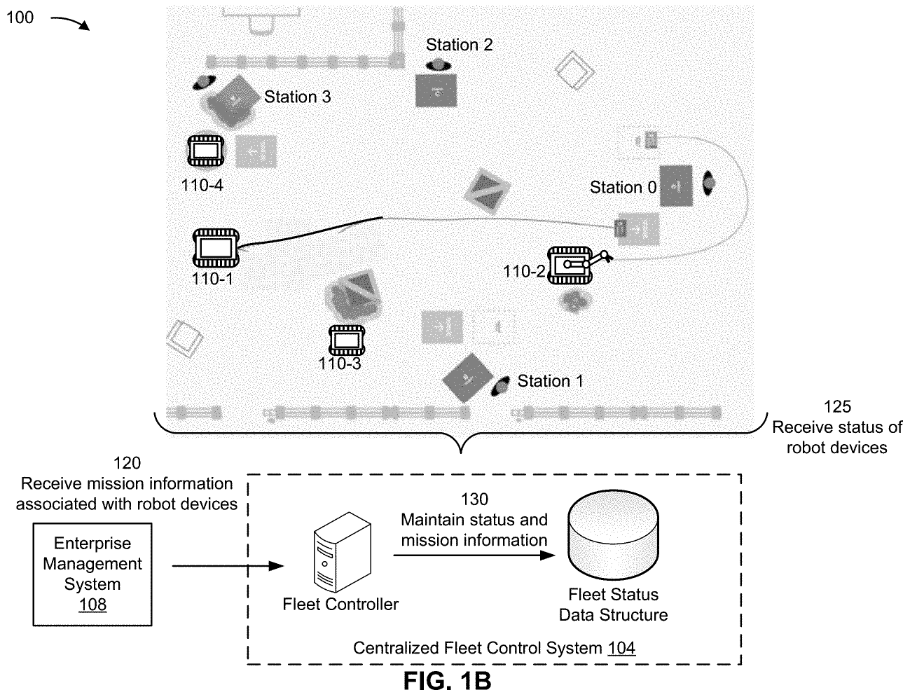

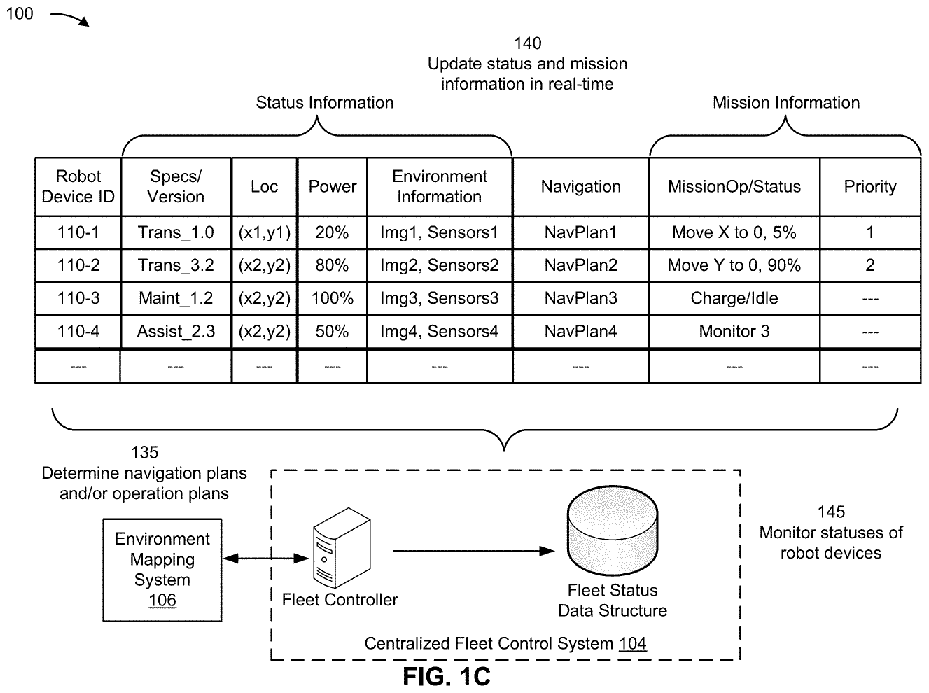

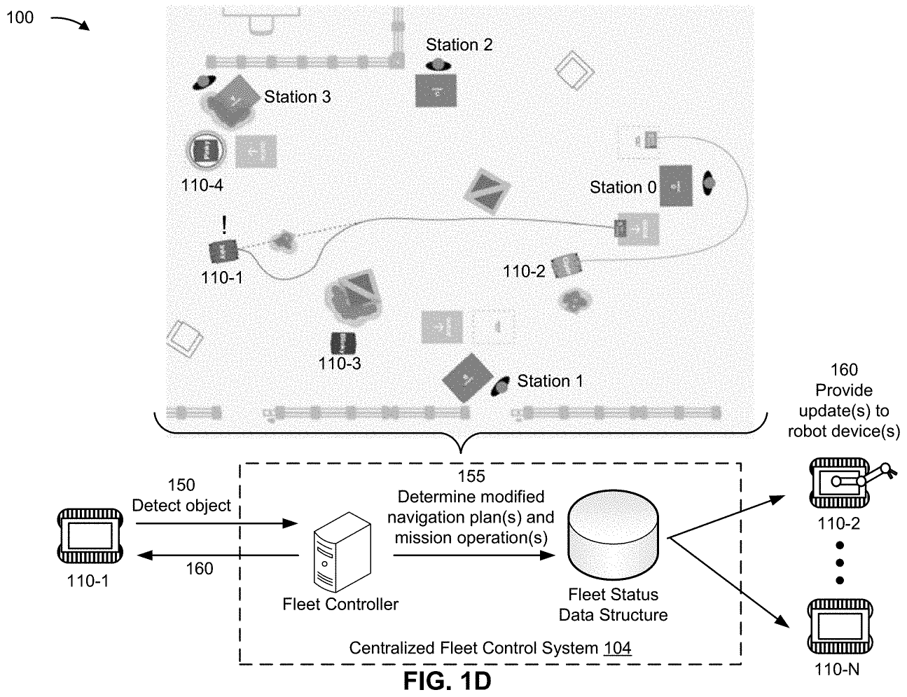

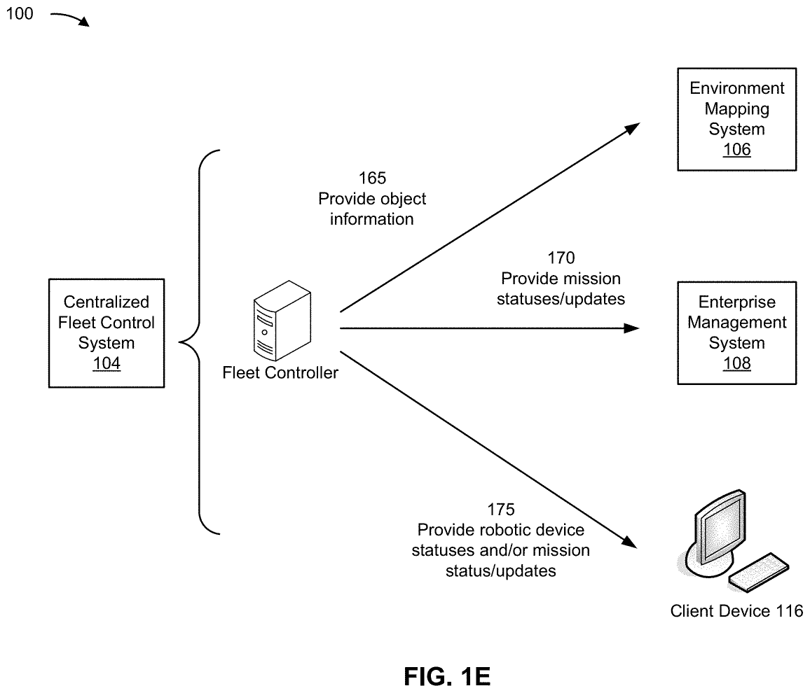

FIGS. 1A-1E are diagrams of an example 100 associated with centralized control of a fleet of robotic devices. As shown in FIG. 1A, a centralized fleet control system 104 is associated with an environment mapping system 106, an enterprise management system 108, and a fleet of robotic devices 110 (e.g., robotic device 110-1, robotic device 110-2, through robotic device 110-N, collectively referred to as robotic devices 110 and individually as robotic device 110).

The centralized fleet control system 104 may be configured to generate a plan for a robotic device 110 to execute in order to complete a task and to direct robotic resources to execute the plan. A plan may include a set of one or more steps (e.g., move to a location, visually scan a shelf, grasp an item, drop an item into a basket, and/or the like) that can be performed with one or more robotic devices. The centralized fleet control system 104 may generate a plan based on information obtained from the environment mapping system 106 and/or the enterprise management system 108, as described herein.

The centralized fleet control system 104 may direct robotic resources to carry out steps of a plan. The centralized fleet control system 104 may interface with one or more components of a robotic device 110 (e.g., a navigation component, a mapping component, an arm component, a gripper component, and/or the like) to cause the robotic device 110 to execute a step of a plan. The centralized fleet control system 104 may interface with the one or more components of the robotic device 110 based on information obtained from one or more robot original equipment manufacturer (OEM) systems 112 (e.g., robot OEM system 112-1 through robot OEM system 112-M, as shown in FIG. 1A). The robot OEM system 112 may include a backend system platform associated with a particular type of robotic device 110. The centralized fleet control system 104 may obtain (e.g., based on providing a request to the robot OEM system 112 via a data network 114) information associated with commands used to control the robotic device 110, an operating system utilized by the robotic device 110, performance metrics (e.g., speed, carrying capacity, and/or the like) associated with the robotic device 110, operating system updates, and/or the like.

The environment mapping system 106 may be configured to generate a map of an environment in which the robotic devices 110 operate. For example, the environment mapping system 106 may generate a 3D mapping indicating boundaries of the environment, known objects (e.g., outer walls, interior walls, doorways, furniture, charging stations, personnel stations, inventory stations, and/or the like), dimensions of the environment, dimensions of a section (e.g., a room, an office, a floor of a building, and/or the like) of the environment, and/or the like. The environment mapping system 106 may be configured to update the mapping of the environment in real-time based on information obtained by the robotic devices 110.

In some implementations, the environment mapping system 106 generates a group of maps corresponding to the environment in which the robotic devices 110 operate. Each map, of the group of maps, may correspond to a respective section of the environment. For example, the environment may include a multi-story building and each map may correspond to a respective floor of the building. A map, of the group of maps, may be linked to another map, of the group of maps, via a defined connection point (e.g., an elevator that allows a robotic device 110 to travel between different floors of the building, a walkway connecting two buildings, and/or the like).

The enterprise management system 108 may be configured to store information associated with a state of an environment in which the robotic devices 110 operate. For example, enterprise management system 108 may store a list of robotic devices 110 operating within the environment, information associated with a status of a robotic device 110 (e.g., available, unavailable, stationary, moving, and/or the like), a current location of a robotic device 110, a list of inventory items located within the environment, inventory locations (e.g., a location of a cabinet or a shelf storing one or more inventory items), a location of an inventory item (e.g., information identifying a shelf on which the inventory item is located, information identifying a position of the inventory item on the shelf, and/or the like), navigable regions within the environment, and/or the like. The enterprise management system 108 may implement a user interface via the client device 116 and may provide, via the user interface, a high-level view indicating active plans (e.g., plans currently being executed by one or more robotic devices 110) and the robotic devices 110 executing the active plans.

In some implementations, the centralized fleet control system 104, environment mapping system 106, and/or enterprise management system 108 are included on separate devices connected via a management network 102. The management network 102 may comprise a multi-access edge computing (MEC) environment. In a MEC environment, computing is enabled by a network architecture that provides computing capabilities to a connected device (e.g., robotic device 110) via computing platforms at or near an edge of a network (e.g., a wireless communication network).

Accordingly, because a MEC environment may provide computing at or near the edge of the network, increased performance may be achieved over networks in which computing is performed topologically and/or physically further from a connected device. For example, the MEC environment may offer improved performance due to less traffic and/or congestion between the connected device and the computing node(s), less latency (due to closer proximity to the connected device), increased flexibility (due to a greater number of computing node(s)), and/or the like. Alternatively, and/or additionally, one or more of the centralized fleet control system 104, the environment mapping system 106, and/or the enterprise management system 108 may be included in the same device.

As shown in FIG. 1B, and by reference number 120, the centralized fleet control system 104 receives mission information associated with the robotic devices 110 from the enterprise management system 108. The mission information may include a request for performance of an operation. For example, the mission information may include a request for performance of a particular task, such as a request for a particular inventory item to be moved from a current location to a new location, a request for a performance of a scan of a particular shelf, and/or the like that can be performed by one or more robotic devices 110. In some implementations, the mission information is input by a user via a user interface provided by the environment mapping system 106 via the client device 116. The environment mapping system 106 may receive the mission information input by the user and may provide the mission information to the centralized fleet control system 104.

As shown by reference number 125, the centralized fleet control system 104 receives statuses of the robotic devices 110. The centralized fleet control system 104 may receive the statuses repeatedly (e.g., via a data stream transmitted by the robotic devices 110), periodically (e.g., every one-half second, every one second, every five seconds, and/or the like), based on providing a request for the statuses to the robotic devices 110, and/or based on an occurrence of an event (e.g., a robotic device 110 detecting an unknown object within the environment, the robotic device 110 traveling a predetermined distance, the robotic device 110 completing a task, and/or the like). In some implementations, the statuses comprise live status information associated with the robotic devices 110. For example, a status received from a robotic device 110 may include a robotic device identifier, information identifying a type and/or a version of a robotic operating system (ROS) associated with the robotic device 110, information indicating a current state of the robotic device 110, information indicating a current mission being performed by the robotic device 110, information indicating a current navigation plan (described in greater detail below) associated with the robotic device 110, a current location of the robotic device 110, a current speed of the robotic device 110, a battery status (e.g., 100%, 50%, fully charged, fully discharged, charging, and/or the like) of the robotic device 110, a capability (e.g., a tool for grasping an item, a structure for carrying an item, a maximum speed, a maximum distance the robotic device 110 is able to travel (e.g., based on a current battery status and/or based on a fully charged battery), and/or the like) of the robotic device 110, a time at which a last mission was performed and/or completed, a quantity of missions performed by the robotic device 110, and/or the like.

As shown by reference number 130, the centralized fleet control system 104 maintains status and mission information associated with the robotic devices 110. For example, the centralized fleet control system 104 may maintain the statuses and mission information associated with each robotic device 110 in a data structure (e.g., a database, a table, a list, and/or the like) stored in a memory associated with the centralized fleet control system 104 (e.g., a memory of the centralized fleet control system 104 and/or a memory of the enterprise management system 108). The mission information may include information indicating whether the robotic device 110 is currently executing a mission and, if so, information associated with the mission being executed by the robotic device 110, such as a navigation plan associated with the robotic device 110, a current location of the robotic device 110, a current task being performed by the robotic device 110, a priority of the mission relative to other active missions, and/or the like. The centralized fleet control system 104 may utilize the stored information to monitor the individual statuses of one or more robotic devices 110 (e.g., a robotic device 110 that is currently performing a mission, a robotic device 110 that is currently idle, a robotic device 110 that is currently recharging a battery of the robotic device 110, and/or the like).

As shown in FIG. 1C, and by reference number 135, the centralized fleet control system 104 determines navigation plans and/or operation plans for the robotic devices 110. The centralized fleet control system 104 may determine the navigation plans and/or the operation plans based on the mission information received from the environment mapping system 106. As an example, the mission information may include information identifying a task. The centralized fleet control system 104 may select a first robotic device 110, of the fleet of robotic devices 110, to perform the task based on monitoring the individual statuses of the robotic devices 110.

In some implementations, the centralized fleet control system 104 selects the first robotic device 110 to perform the task based on a location of the first robotic device 110 and a location associated with the task. The centralized fleet control system 104 may determine a location associated with the task based on the mission information. As an example, the mission information may include a location of an inventory item that is to be moved to a new location. The centralized fleet control system 104 may determine a current location of the robotic devices 110 based on the statuses of the robotic devices 110. The centralized fleet control system 104 may determine that a current location of the first robotic device 110 is closer to the location of the inventory item relative to the current locations of the other robotic devices 110. The centralized fleet control system 104 may select the first robotic device 110 based on the current location of the first robotic device 110 being closer to the location of the inventor item relative to the current locations of the other robotic devices 110.

In some implementations, the centralized fleet control system 104 selects the first robotic device 110 based on a period of time until the first robotic device is available to perform the task. The centralized fleet control system 104 may determine a respective period of time until each robotic device 110 is available to perform the task. The centralized fleet control system 104 may select the first robotic device 110 based on the period of time being less than a time threshold (e.g., zero seconds (e.g., the first robotic device 110 is currently idle), thirty seconds, one minute, and/or the like), based on the period of time until the first robotic device 110 is available to perform the task being less than a period of time than the other robotic devices 110 are available to perform the task, and/or the like.

In some implementations, the centralized fleet control system 104 selects the first robotic device 110 based on a performance characteristic of the first robotic device 110. The centralized fleet control system 104 may determine a requirement associated with the task, such as a requirement to grasp an item, a particular type of item, a particular size of item, and/or the like from a shelf, a requirement to carry a particular amount of weight (e.g., a weight of an inventory item to be retrieved), a requirement to travel at a particular speed, a requirement to travel across a particular type of terrain (e.g., up and/or down a set of stairs, across a carpet, and/or the like), a requirement to travel a certain distance, and/or the like. The centralized fleet control system 104 may determine that the first robotic device 110 is able to meet the requirement based on a performance characteristic (e.g., a grasping capability, a carrying capability, a maximum speed, a capability to traverse particular types of terrain, a maximum travel distance, health information (e.g., a battery status, an amount of available memory, and/or the like), and/or the like) of the first robotic device 110.

The centralized fleet control system 104 may determine a navigation plan based on selecting the first robotic device 110. In some implementations, the centralized fleet control system 104 determines the navigation plan based on a plurality of navigation plans associated with the first robotic device 110. For example, the centralized fleet control system 104 may determine a plurality of potential navigation plans associated with the first robotic device 110 performing the task based on a mapping of the environment obtained from the environment mapping system 106.

The plurality of potential navigation plans may be associated with the first robotic device 110 traveling from a current location of the first robotic device 110 to one or more locations associated with the mission (e.g., a location of an inventory item, a location to which the inventory item is to be moved and/or delivered, a location to which the first robotic device 110 is to return after moving and/or delivering the inventory item, and/or the like). For example, a potential navigation plan, of the plurality of potential navigation plans, may include information identifying a route the first robotic device 110 is to travel through the environment to the location of the inventory item, a route the first robotic device 110 is to travel through the environment to a location to which the inventory item is to be moved and/or delivered, a route the first robotic device 110 is to travel to the location to which the first robotic device 110 is to return after moving and/or delivering the inventory item, and/or the like.

In some implementations, the potential navigation plan includes information identifying a set of maps of the environment associated with the route the first robotic device 110 is to travel. A map, of the set of maps, may be associated with a coordinate system, and the information identifying the route may include sets of coordinates to which the first robotic device 110 is to travel. In some implementations, the coordinate system is an (X, Y) coordinate system and the X coordinate values and the Y coordinate values are expressed in meters from a lower-left corner of the map.

The centralized fleet control system 104 may select the navigation plan for the first robotic device 110 to perform the task from the plurality of potential navigation plans. In some implementations, the centralized fleet control system 104 selects the navigation plan based on a respective cost associated with each of the plurality of navigation plans. In some implementations, the centralized fleet control system 104 determines the cost associated with a potential navigation plan based on an amount of time required for the first robotic device 110 to perform the task based on the first robotic device 110 traveling the route identified by the potential navigation plan. The centralized fleet control system 104 may determine a distance the first robotic device 110 is to travel based on the route identified by the potential navigation plan. The centralized fleet control system 104 may determine a speed of travel (e.g., a maximum speed, an average speed, and/or the like) associated with the first robotic device 110 based on the status information associated with the first robotic device 110. The centralized fleet control system 104 may determine a travel time indicating an amount of time for the first robotic device 110 to travel the distance based on the speed associated with the first robotic device 110 (e.g., by dividing the distance by the speed).

In some implementations, the centralized fleet control system 104 modifies the travel time based on a quantity of connection points the first robotic device 110 must traverse. At each connection point, the first robotic device 110 may experience a delay corresponding to an amount of time required for the first robotic device 110 to replace a current map (e.g., a map corresponding to a floor on which the first robotic device 110 is current located) with a new map (e.g., a map corresponding to a floor to which the first robotic device 110 is to travel via the connection point).

The centralized fleet control system 104 may add, to the travel time, an amount of time corresponding to a delay experienced by the first robotic device 110 at each connection point the first robotic device 110 is to traverse. The centralized fleet control system 104 may determine a total travel time by adding an amount of time until the first robotic device 110 is available to the modified travel time. The centralized fleet control system 104 may determine the cost associated with the potential navigation plan based on the total travel time. The centralized fleet control system 104 may select a potential navigation plan, from the plurality of potential navigation plans, as the navigation plan based on the potential navigation plan being associated with the lowest cost relative to the other potential navigation plans.

In some implementations, the centralized fleet control system 104 selects the navigation plan based on a probability of the first robotic device 110 colliding with another robotic device 110 operating within the environment. The centralized fleet control system 104 may determine, for the plurality of potential navigation plans, respective probabilities of the first robotic device 110 colliding with another robotic device 110 of the fleet of robotic devices 110. The centralized fleet control system 104 may select a potential navigation plan as the navigation plan based on the potential navigation plan being associated with a lowest probability of the respective probabilities.

The centralized fleet control system 104 may provide the navigation plan and/or may stream navigation instructions associated with the navigation plan to the first robotic device 110 to cause the first robotic device 110 to traverse the environment according to the navigation plan based on selecting the navigation plan. In some implementations, the centralized fleet control system 104 may provide the navigation plan and/or the navigation instructions to the first robotic device 110 in a messaging format associated with the first robotic device 110. As an example, the centralized fleet control system 104 may determine a type of the first robotic device 110 and/or an operating system associated with the first robotic device 110 based on status information associated with the first robotic device 110 and stored in the data structure maintained by the enterprise management system 108. The centralized fleet control system 104 may determine a messaging format associated with the first robotic device 110 based on the type of the first robotic device 110 and/or the operating system associated with the first robotic device 110. The centralized fleet control system 104 may provide the navigation plan and/or the navigation instructions to the first robotic device 110 using the messaging format based on the messaging format being associated with the first robotic device 110.

In some implementations, the centralized fleet control system 104 determines a second navigation plan associated with a second robotic device 110 performing a second mission. The navigation plan associated with the first robotic device 110 may include a path that traverses a particular area of the environment. The centralized fleet control system 104 may determine the second navigation plan to cause the second robotic device 110 to avoid the particular area when the first robotic device 110 is scheduled to be in the particular area according to the navigation plan associated with the first robotic device 110. The centralized fleet control system 104 may store the second navigation plan in the data structure in an entry associated with the second robotic device 110. The data structure may identify the navigation plan associated with the first robotic device 110 in an entry associated with the first robotic device 110.

In some implementations, the centralized fleet control system 104 determines that a navigation plan associated with a second robotic device 110 and the navigation plan associated with the first robotic device 110 indicate that the first robotic device 110 has a threshold probability of colliding with the second robotic device 110. The centralized fleet control system 104 may determine an update to the navigation plan associated with the second robotic device 110 to generate an updated navigation plan for the second robotic device 110. The centralized fleet control system 104 may stream, to the second robotic device 110, updated navigation instructions associated with the updated navigation plan to reduce a probability that the first robotic device 110 and the second robotic device 110 collide.

As shown by reference number 140, the centralized fleet control system 104 updates status and mission information in real-time. The centralized fleet control system 104 may update the status and mission information associated with the first robotic device 110 to include information identifying the mission, a priority of the mission relative to other active missions, the selected navigation plan, a current status of the mission, an estimated start time for the mission, and/or the like.

As shown by reference number 145, the centralized fleet control system 104 monitors statuses of the robotic devices 110. The robotic devices 110 may stream information obtained by one or more sensors of the robotic devices 110 (e.g., a current speed, a current location, a current mission, an image of a portion of the environment in which the robotic device 110 is currently located, and/or the like) via a low-latency wireless communication link. The centralized fleet control system 104 may monitor the statuses and/or update the status information and/or the mission information for the robotic devices 110 based on the streamed information received from the robotic devices 110.

In some implementations, the centralized fleet control system 104 may modify mission information for a robotic device 110 based on monitoring the statuses of the robotic devices 110. For example, the centralized fleet control system 104 may determine that a battery level of a robotic device satisfies a battery level threshold (e.g., 10%, 20%, and/or the like) based on monitoring the statuses of the robotic devices 110. The centralized fleet control system 104 may raise a priority of a mission associated with the robotic device 110 to prioritize the mission over missions associated with other robotic devices 110 based on the battery level satisfying the battery level threshold. The centralized fleet control system 104 may raise the priority level of the mission to enable the robotic device 110 to complete the mission and/or to travel to a recharging station prior to the battery being fully discharged.

In some implementations, the centralized fleet control system 104 may modify a navigation plan based on monitoring the statuses of the robotic devices 110. As shown in FIG. 1D, and by reference number 150, the centralized fleet control system 104 receives information identifying a detected object from the first robotic device 110 (e.g., robotic device 110-1, as shown in FIG. 1D). In some implementations, the object may be detected by the first robotic device 110. For example, the first robotic device 110 may obtain environment data as the first robotic device 110 traverses the environment according to the navigation plan associated with the first robotic device 110. The environment data may include sensor data obtained by one or more sensors (e.g., LIDAR, radar, and/or the like) of the first robotic device 110, one or more images captured by a camera device of the first robotic device 110, and/or the like. The first robotic device 110 may analyze the environment data and may detect the object and/or one or more characteristics of the object based on the analysis. For example, the first robotic device 110 may detect a presence of an object, a type of the object (e.g., a chair, an inanimate object, another robotic device 110, a person, an animal, and/or the like), a location of the object within the environment, a time at which the object was detected, and/or the like. The first robotic device 110 may provide information identifying the object and/or the one or more characteristics of the object to the centralized fleet control system 104. Alternatively, and/or additionally, the first robotic device 110 may provide the environment data to the centralized fleet control system 104, and the centralized fleet control system 104 may analyze the environment data to detect the object and/or the one or more characteristics of the object.

As shown by reference number 155, the centralized fleet control system 104 determines a modified navigation plan and mission operation. The centralized fleet control system 104 may determine, based on detecting the object, a modified navigation plan and mission operation for each robotic device 110, for each robotic device 110 associated with an active mission, for each robotic device 110 located within a predetermined distance (e.g., within five meters, on the same floor of a building, and/or the like) of the first robotic device 110, for each robotic device 110 associated with a navigation plan that may be affected by the detected object, and/or the like.

As an example, the centralized fleet control system 104 may determine a location of the detected object and a type of the detected object based on sensor data received from the first robotic device 110. The centralized fleet control system 104 may determine that a route to be traveled by the first robotic device 110 will cause the first robotic device 110 to collide with the detected object based on the location of the detected object and based on the navigation plan associated with the first robotic device 110. The centralized fleet control system 104 may modify the navigation plan associated with the first robotic device 110 to cause the first robotic device 110 to travel around the detected object based on determining that the route to be traveled by the first robotic device 110 will cause the first robotic device 110 to collide with the detected object.

In some implementations, the centralized fleet control system 104 modifies the navigation plan associated with the first robotic device 110 based on the type of the detected object. For example, the centralized fleet control system 104 may modify the navigation plan to cause the first robotic device 110 to avoid the detected object by a first distance (e.g., one meter) when the detected object is a first type of object (e.g., an inanimate object) and the centralized fleet control system 104 may modify the navigation plan to cause the first robotic device 110 to avoid the detected object by a second distance (e.g., two meters) when the detected object is a second type of object (e.g., a person). As shown in FIG. 1D, the centralized fleet control system 104 modifies the navigation plan associated with the first robotic device 110 to cause the first robotic device 110 to travel around the detected object.

In some implementations, the centralized fleet control system 104 modifies the navigation plan of another robotic device 110 based on detecting the object. The centralized fleet control system 104 may determine, based on the environment information received from the first robotic device 110, a location of the detected object. The centralized fleet control system 104 may determine that the location of the detected object is within a path of a second navigation plan associated with performance of the second operation by the second robotic device 110. The centralized fleet control system 104 may update the second navigation plan to include a new path that avoids the location of the detected object. The centralized fleet control system 104 may provide the updated second navigation plan to the second robotic device 110 to cause the second robotic device 110 to avoid the detected object.

As shown by reference number 160, the centralized fleet control system 104 provides an update to the robotic devices 110. In some implementations, the centralized fleet control system 104 provides an update (e.g., a modified navigation plan, information associated with the detected object, and/or the like) to each robotic device 110 for which a modified navigation plan and/or mission operation was determined. In some implementations, the centralized fleet control system 104 provides an update to each robotic device 110 of the fleet of robotic devices 110.

As shown in FIG. 1E, and by reference number 165, the centralized fleet control system 104 provides object information to the environment mapping system 106. In some implementations, the centralized fleet control system 104 determines, based on the location of the detected object, that the detected object is not identified in a map currently being utilized by the first robotic device 110. The centralized fleet control system 104 may provide object information to the environment mapping system 106 based on the detected object not being identified in the map. The object information may include information identifying the detected object, a type of the detected object, a location of the detected object, information identifying the map currently being utilized by the first robotic device 110, and/or the like. The environment mapping system 106 may update the map currently being utilized by the first robotic device 110 to include the detected object at the location of the detected object based on the object information provided by the centralized fleet control system 104.

In some implementations, the centralized fleet control system 104 may provide the object information based on a quantity of robotic devices 110 detecting the object and/or based on the object being determined to be within the environment for a threshold amount of time. In this way, the centralized fleet control system 104 may prevent the map from being updated to include objects temporarily located within the environment (e.g., a person walking through the environment, another robotic device 110 traveling through the environment, and/or the like).

As shown by reference number 170, the centralized fleet control system 104 provides mission statuses and/or updates to the enterprise management system 108. For example, the centralized fleet control system 104 may provide information associated with modifying the navigation plans and/or the mission operations to the enterprise management system 108. The enterprise management system 108 may store the information in a data structure to update the statuses and mission information for one or more of the robotic devices 110 (e.g., the first robotic device 110, the second robotic device 110, and/or the like).

As shown by reference number 175, the centralized fleet control system 104 provides robotic device statuses and/or mission statuses and/or updates to the client device 116. The centralized fleet control system 104 may provide the robotic device statuses and/or mission statuses and/or updates to the client device 116 via the enterprise management system 108. The enterprise management system 108 may provide the robotic device statuses and/or mission statuses and/or updates to the client device 116 to cause the client device 116 to provide the robotic device statuses and/or mission statuses and/or updates to a user via a user interface associated with the centralized fleet control system 104. In this way, the centralized fleet control system 104 may enable a user to track a status of a mission and/or a status of a robotic device 110 in real-time.

In this way, the centralized fleet control system 104 may centralize control of a fleet of mobility-enabled, connected, robotic devices 110 to enable the positioning and navigation, communication, collision prevention, coordination, and task operation of the robotic devices 110. The centralized fleet control system 104 may eliminate the need for expensive sensors, onboard processing, and local data hosting requirements for the robotic devices 110 and creates scalable and centralized inter-robotic device collaboration and coordination.

Further, in some implementations, the centralized fleet control system 104 may run all processing for the fleet of robotic devices 110 on an edge computer over a low latency wireless link. As a result, software, algorithms, and architecture are run on an edge computer, rather than a robotic device 110, thereby reducing an amount of computing resources required to be included on the robotic devices 110. The centralized fleet control system can manage hundreds, thousands, and/or tens of thousands of robotic devices 110 by simultaneously ingesting sensor information received from the robotic devices 110, using AI and ML to process the sensor information in near real-time to enable centralized multi-robotic device localization in near real-time using a global map, collision avoidance between dynamic and static objects around all robotic devices 110 and robotic device traffic management, real-time object recognition and decision making for all robotic devices 110, real-time path planning and navigation for all robotic devices 110, real-time mission execution on all robotic devices 110, a centralized safety command system reacting in near real-time speed, inter-robotic device collaboration and cooperation, and/or the like.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

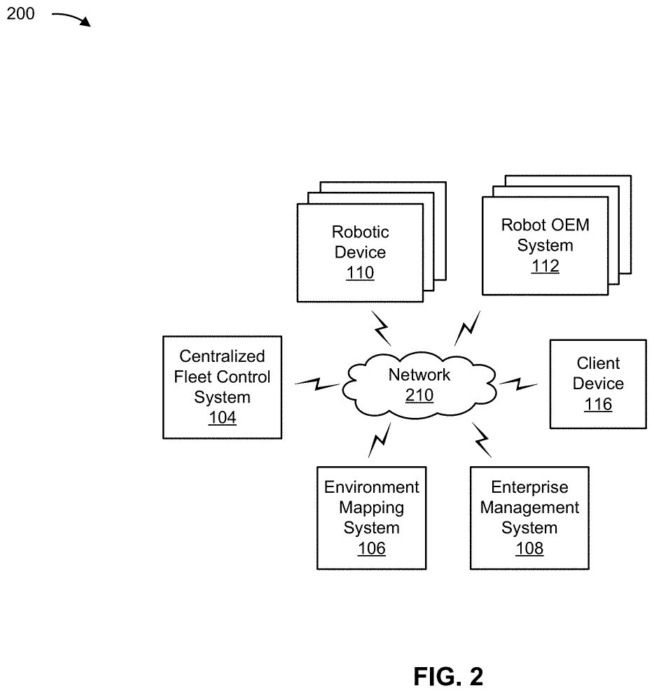

FIG. 2 is a diagram of an example environment 200 in which systems and/or methods described herein may be implemented. As shown in FIG. 2, environment 200 may include a centralized fleet control system 104, an environment mapping system 106, an enterprise management system 108, a robotic device 110, a robot OEM system 112, a client device 116, and a network 210. Devices of environment 200 may interconnect via wired connections, wireless connections, or a combination of wired and wireless connections.

Centralized fleet control system 104 includes one or more devices capable of receiving, generating, storing, processing, and/or providing information associated with centralized control of a fleet of robotic devices, as described herein. Centralized fleet control system 104 may include a communication device and/or a computing device. For example, centralized fleet control system 104 may include a network device included in a multi-access edge computing (MEC) environment. In a MEC environment, computing is enabled by a network architecture that provides computing capabilities to a connected device (e.g., robotic device 110) via computing platforms at or near an edge of a network (e.g., a wireless communication network).

Alternatively, and/or additionally, centralized fleet control system 104 may include a server, such as an application server, a client server, a web server, a database server, a host server, a proxy server, a virtual server (e.g., executing on computing hardware), or a server in a cloud computing system. In some implementations, centralized fleet control system 104 includes computing hardware used in a cloud computing environment.

Environment mapping system 106 includes one or more devices capable of receiving, generating, storing, processing, and/or providing information associated with centralized control of a fleet of robotic devices, as described elsewhere herein. Environment mapping system 106 may be configured to generate a map of an environment in which robotic device 110 operates and may be configured to update the mapping of the environment in real-time based on information obtained by robotic device 110. Environment mapping system 106 may include a communication device and/or a computing device. For example, environment mapping system 106 may include a network device included in a MEC environment. Alternatively, and/or additionally, environment mapping system 106 may include a server, such as an application server, a client server, a web server, a database server, a host server, a proxy server, a virtual server (e.g., executing on computing hardware), or a server in a cloud computing system. In some implementations, environment mapping system 106 includes computing hardware used in a cloud computing environment.

Enterprise management system 108 includes one or more devices capable of receiving, generating, storing, processing, and/or providing information associated with centralized control of a fleet of robotic devices, as described elsewhere herein. Enterprise management system 108 may be configured to store information associated with a state of an environment in which robotic device 110 operates. Enterprise management system 108 may include a communication device and/or a computing device. For example, enterprise management system 108 may include a network device included in a MEC environment. Alternatively, and/or additionally, enterprise management system 108 may include a server, such as an application server, a client server, a web server, a database server, a host server, a proxy server, a virtual server (e.g., executing on computing hardware), or a server in a cloud computing system. In some implementations, enterprise management system 108 includes computing hardware used in a cloud computing environment.

Robotic device 110 includes one or more devices capable of receiving, generating, storing, processing, and/or providing information associated with performing a mission, as described elsewhere herein. Robotic device may include a communication device and/or a computing device that can be programmed to carry out a series of actions automatically based on instructions received from centralized fleet control system 104.

Robot OEM system 112 includes one or more devices capable of receiving, generating, storing, processing, and/or providing information associated with centralized control of a fleet of robotic devices, as described elsewhere herein. Robot OEM system 112 may include a communication device and/or a computing device. For example, robot OEM system 112 may include a server, such as an application server, a client server, a web server, a database server, a host server, a proxy server, a virtual server (e.g., executing on computing hardware), or a server in a cloud computing system. In some implementations, robot OEM system 112 includes computing hardware used in a cloud computing environment.

Client device 116 includes one or more devices capable of receiving, generating, storing, processing, and/or providing information associated with centralized control of a fleet of robotic devices, as described elsewhere herein. Client device 116 may include a communication device and/or a computing device. For example, client device 116 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), and/or a similar type of device.

Network 210 includes one or more wired and/or wireless networks. For example, network 210 may include a cellular network, a public land mobile network (PLMN), a local area network (LAN), a wide area network (WAN), a private network, the Internet, and/or the like, and/or a combination of these or other types of networks. Network 210 enables communication among the devices of environment 200 and may correspond to management network 102 and/or data network 114.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

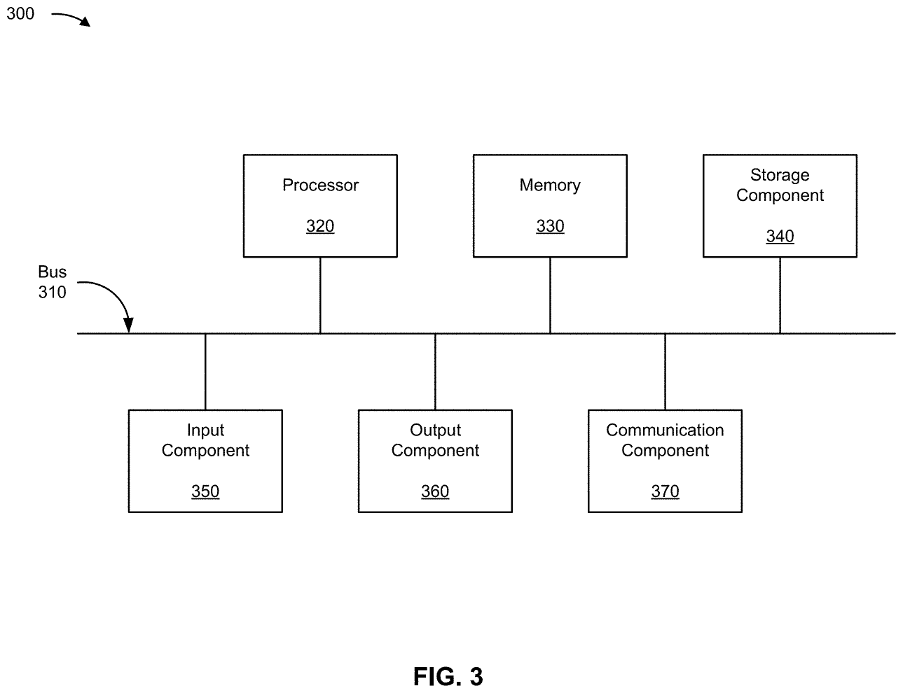

FIG. 3 is a diagram of example components of a device 300, which may correspond to centralized fleet control system 104, client device 116, enterprise management system 108, environment mapping system 106, robot OEM system 112, and/or robotic device 110. In some implementations, centralized fleet control system 104, client device 116, enterprise management system 108, environment mapping system 106, robot OEM system 112, and/or robotic device 110 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

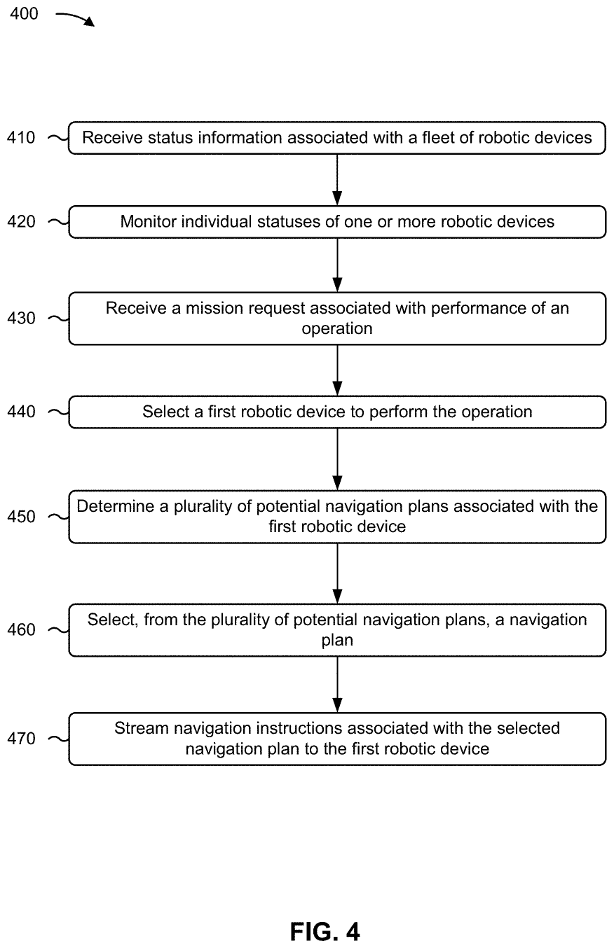

FIG. 4 is a flowchart of an example process 400 associated with centralized control of a fleet of robotic devices. In some implementations, one or more process blocks of FIG. 4 may be performed by a device (e.g., centralized fleet control system 104). In some implementations, one or more process blocks of FIG. 4 may be performed by another device or a group of devices separate from or including the device, such as a client device (e.g., client device 116), an operation management system (e.g., enterprise management system 108), an environment mapping system (e.g., environment mapping system 106), a robot OEM system (e.g., robot OEM system 112), and/or a robotic device (e.g., robotic device 110). Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include receiving status information associated with a fleet of robotic devices (block 410). For example, the device may receive, via a network, status information associated with a fleet of robotic devices associated with an enterprise, as described above. The status information may include individual locations and individual navigation plans of one or more robotic devices of the fleet. In some implementations, the status information may comprise live status information that is repeatedly received from one or more of the robotic devices. The network may comprise a MEC network that is associated with the enterprise.

As further shown in FIG. 4, process 400 may include monitoring individual statuses of one or more robotic devices (block 420). For example, the device may monitor, based on the status information, individual statuses of the one or more robotic devices, as described above.

As further shown in FIG. 4, process 400 may include receiving a mission request associated with performance of an operation (block 430). For example, the device may receive a mission request associated with performance of an operation of the enterprise, as described above.

As further shown in FIG. 4, process 400 may include selecting a first robotic device to perform the operation (block 440). For example, the device may select, based on the individual statuses, a first robotic device to perform the operation, as described above. The device may select the first robotic device to perform the operation based on a location of the first robotic device and a location associated with the operation, a duration of a time period until the first robotic device is available to perform the operation, and/or a performance characteristic of the robotic device and a parameter of the operation.

As further shown in FIG. 4, process 400 may include determining a plurality of potential navigation plans associated with the first robotic device (block 450). For example, the device may determine, based on a mapping of an environment of the enterprise, a plurality of potential navigation plans associated with the first robotic device traversing the environment according to the operation, as described above.

As further shown in FIG. 4, process 400 may include selecting, from the plurality of potential navigation plans, a navigation plan (block 460). For example, the device may select, from the plurality of potential navigation plans, a navigation plan based on the individual locations and the individual navigation plans, as described above. In some implementations, the device may determine, for the plurality of potential navigation plans, respective probabilities of the first robotic device colliding with another robotic device of the fleet. The device may select the navigation plan based on the navigation plan being associated with a lowest probability of the respective probabilities.

Alternatively, and/or additionally, the device may obtain status information and mission information associated with the first robotic device from a fleet management data structure. The device may select the navigation plan based on the status information and the mission information. In some implementations, the device may update the status information in a fleet management data structure to be included in the selected navigation plan.

In some implementations, the device may determine a second navigation plan associated with a second robotic device performing a second mission. The navigation plan associated with the first robotic device may include a path that traverses an area of a station of the enterprise. The second navigation plan may be configured to cause the second robotic device to avoid the area when the first robotic device is scheduled to be in the area according to the navigation plan associated with the first robotic device. The device may store the second navigation plan in a fleet management data structure in an entry associated with the second robotic device. The fleet management data structure may identify the navigation plan associated with the first robotic device in an entry associated with the first robotic device.

As further shown in FIG. 4, process 400 may include streaming navigation instructions associated with the selected navigation plan to the first robotic device (block 470). For example, the device may stream navigation instructions associated with the selected navigation plan to the first robotic device to cause the first robotic device to traverse the environment according to the selected navigation plan, as described above. In some implementations, the first robotic device may comprise a first type of robotic device and the device may provide the navigation instructions to the first robotic device using a first messaging format associated with the first type of robotic device.

In some implementations, the device may receive, from the first robotic device, environment information associated with an environment of the first robotic device. The device may determine, from the environment information, that an object is in a path of the navigation plan. The device may update the path of the navigation plan based on the environment information and the individual locations and individual navigation plans. The device may stream the navigation instructions, according to the updated path, to the first robotic device to cause the first robotic device to avoid a collision with the object.

In some implementations, the device may determine a type of the object. The device may determine, based on the type of the object, that the mapping is to be updated to include the object. The device may update the mapping to include information that identifies a location of the object and/or the type of the object.

In some implementations, the device may detect that a particular navigation plan of the individual navigation plans and the selected navigation plan indicate that the first robotic device has a threshold probability of colliding with a second robotic device that is associated with the particular navigation plan. The device may determine, based on the selected navigation plan and one or more other individual navigation plans, an update to the particular navigation plan to generate an updated navigation plan for the second robotic device. The device may stream, to the second robotic device, updated navigation instructions associated with the updated navigation plan to reduce a probability that the first robotic device and the second robotic device collide.

In some implementations, the device may receive first status information associated with performance of the first operation by the first robotic device and second status information associated with performance of the second operation by the second robotic device. The first status information may comprise live location information that is repeatedly received from the first robotic device during performance of the first operation and the second status information may comprise live location information that is repeatedly received from the second robotic device. The device may store the first status information and the second status information in a fleet management data structure.

The device may receive, from the first robotic device, first status information. The device may determine, from the first status information, that an object in the environment is within a threshold distance of the first robotic device. The device may determine, based on a location of the object, that the object is not identified in the mapping. The device may determine that the location of the object is within a path of a second navigation plan associated with performance of the second operation by the second robotic device. The device may update the second navigation plan to include a new path that avoids the location of the object. The device may provide the updated second navigation plan to the second robotic device to cause the second robotic device to avoid the object.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device and via a network, status information associated with a fleet of robotic devices associated with an enterprise,
wherein the status information includes individual locations and individual navigation plans of one or more robotic devices of the fleet;
monitoring, by the device and based on the status information, individual statuses of the one or more robotic devices;
receiving, by the device, a mission request associated with performance of an operation of the enterprise;
selecting, by the device and based on the individual statuses, a first robotic device to perform the operation;
determining, by the device and based on a mapping of an environment of the enterprise, a plurality of potential navigation plans associated with the first robotic device traversing the environment according to the operation;
selecting, by the device and from the plurality of potential navigation plans, a navigation plan based on the individual locations and the individual navigation plans; and
streaming, by the device, navigation instructions associated with the selected navigation plan to the first robotic device to cause the first robotic device to traverse the environment according to the selected navigation plan.

2. The method of claim 1, wherein the status information comprises live status information that is repeatedly received from the one or more robotic devices.

3. The method of claim 1, wherein the first robotic device is selected to perform the operation based on at least one of:
a location of the first robotic device and a location associated with the operation;
a duration of a time period until the first robotic device is available to perform the operation; or
a performance characteristic of the first robotic device and a parameter of the operation.

4. The method of claim 1, wherein selecting the navigation plan comprises:
determining, for the plurality of potential navigation plans, respective probabilities of the first robotic device colliding with another robotic device of the fleet of robotic devices; and
selecting the selected navigation plan based on the selected navigation plan being associated with a lowest probability of the respective probabilities.

5. The method of claim 1, further comprising:
receiving, from the first robotic device, environment information associated with an environment of the first robotic device;
determining, from the environment information, that an object is in a path of the navigation plan;
updating the path of the navigation plan based on the environment information and the individual locations and individual navigation plans; and
streaming the navigation instructions, according to the updated path, to the first robotic device to cause the first robotic device to avoid a collision with the object.

6. The method of claim 5, further comprising:
determining a type of the object;
determining, based on the type of the object, that the mapping is to be updated to include the object; and
updating the mapping to include information that identifies a location of the object or the type of the object.

7. The method of claim 1, further comprising:
updating the status information in a fleet management data structure to include the selected navigation plan.

8. The method of claim 1, further comprising:
detecting that a particular navigation plan of the individual navigation plans and the selected navigation plan indicate that the first robotic device has a threshold probability of colliding with a second robotic device that is associated with the particular navigation plan;
determining, based on the selected navigation plan and one or more other individual navigation plans, an update to the particular navigation plan to generate an updated navigation plan for the second robotic device; and
streaming, to the second robotic device, updated navigation instructions associated with the updated navigation plan to reduce a probability that the first robotic device and the second robotic device collide.

9. A device, comprising:
one or more processors configured to:
receive, via a network, first mission information associated with a first robotic device performing a first operation of an enterprise;
receive, via the network, second mission information associated a second robotic device performing a second operation of the enterprise,
wherein the first robotic device and the second robotic device are associated with a fleet of robotic devices of the enterprise;
determine a first navigation plan for the first robotic device to perform the first operation and a second navigation plan for the second robotic device to perform the second operation based on:
the first mission information,
the second mission information,
one or more other navigation plans associated with one or more other robotic devices of the fleet of robotic devices, and
a mapping of an environment of the enterprise;
provide, via the network, the first navigation plan and the first mission information to the first robotic device to cause the first robotic device to perform the first operation according to the first navigation plan; and
provide, via the network, the second navigation plan and the second mission information to the second robotic device to cause the second robotic device to perform the second operation according to the second navigation plan.

10. The device of claim 9, wherein the one or more processors are further configured to:
receive first status information associated with performance of the first operation by the first robotic device;
receive second status information associated with performance of the second operation by the second robotic device; and
store the first status information and the second status information in a fleet management data structure.

11. The device of claim 10, wherein the first status information comprises live location information that is repeatedly received from the first robotic device during performance of the first operation and the second status information comprises live location information that is repeatedly received from the second robotic device.

12. The device of claim 9, wherein the first robotic device is selected from the fleet to perform the first operation based on a location of the first robotic device and a location associated with the first operation, and
wherein the second robotic device is selected from the fleet of robotic devices to perform the second operation based on a location of the second robotic device and a location associated with the second operation.

13. The device of claim 9, wherein the first navigation plan is provided to the first robotic device using a first messaging format associated with a first type of robotic device, and
wherein the second navigation plan is provided to the second robotic device using a second messaging format, associated with a second type of robotic device, that is different from the first type of robotic device.

14. The device of claim 9, wherein the one or more processors are further configured to:
receive, from the first robotic device, first status information;
determine, from the first status information, that an object in the environment is within a threshold distance of the first robotic device;
determine, based on a location of the object, that the object is not identified in the mapping; and
determine that the location of the object is within a path of the second navigation plan;
update the second navigation plan to include a new path that avoids the location of the object; and
provide the updated second navigation plan to the second robotic device to cause the second robotic device to avoid the object.

15. A non-transitory computer-readable medium storing a set of instructions, the set of instructions comprising:
one or more instructions that, when executed by one or more processors of a device, cause the device to:
receive, via a network, a mission request associated with performance of an operation at a station of an enterprise;
determine, based on receiving the mission request, a first navigation plan of a first robotic device of a fleet of robotic devices of the enterprise,
wherein the first navigation plan includes a path that traverses an area of the station;
select, from the fleet of robotic devices and based on the first navigation plan, a second robotic device to perform the operation;
determine, based on a mapping associated with an environment of the operation, a plurality of potential navigation plans associated with the second robotic device traversing the environment according to the operation;
select, from the plurality of potential navigation plans, a second navigation plan based on the first navigation plan and the mapping; and
provide, via the network, the second navigation plan to the second robotic device to cause the second robotic device to traverse the environment according to the second navigation plan.

16. The non-transitory computer-readable medium of claim 15, wherein the second robotic device is selected to perform the operation based on at least one of:
a location of the second robotic device and a location associated with the operation;
a duration of a time period until the second robotic device is available to perform the operation; or
a performance characteristic of the second robotic device and a parameter of the operation.

17. The non-transitory computer-readable medium of claim 15, wherein the one or more instructions that cause the device to determine the first navigation plan cause the device to:
obtain, from a fleet management data structure, status information and mission information associated with the first robotic device; and
determine the first navigation plan based on the status information and the mission information.

18. The non-transitory computer-readable medium of claim 15, wherein the second navigation plan is configured to cause the second robotic device to avoid the area when the first robotic device is scheduled to be in the area according to the first navigation plan.

19. The non-transitory computer-readable medium of claim 15, wherein the one or more instructions further cause the device to:
store the second navigation plan in a fleet management data structure in an entry associated with the second robotic device,
wherein the fleet management data structure identifies the first navigation plan in an entry associated with the first robotic device.

20. The non-transitory computer-readable medium of claim 15, wherein the network comprises a mobile edge computing network that is associated with the enterprise.
